(19) United States
(12) Patent Application Publication
(10) Pub. No.: US 2017/0144899 A1
(43) Pub. Date: May 25, 2017

(54) WATER SANITIZATION SYSTEM

(71) Applicant: VISION WORKS IP CORPORATION, Sequim, WA (US)

(72) Inventor: Fritz Braunberger, Sequim, WA (US)

(21) Appl. No.: 15/424,499

(22) Filed: Feb. 3, 2017

Related U.S. Application Data
(63) Continuation-in-part of application No. 14/133,319, filed on Dec. 18, 2013, now Pat. No. 9,598,294.

(51) Int. Cl. C02F 1/32; E04H 4/16; C02F 1/48

(52) U.S. Cl. CPC C02F 1/325; C02F 1/48; E04H 4/16; C02F 2103/42

(57) ABSTRACT

A water sanitization system is able to sanitize water for drinking and other uses. A mechanically operable water sanitization system comprises an inlet port, an outlet port and a base comprising one or more sanitization mechanisms. A mechanical device such as a crank operated pump passes water through the base and by the one or more sanitization mechanisms. The one or more sanitization mechanisms sanitize the water and the water is passed out of the system through the outlet port. The outlet port is able to distribute the water, to a bucket and/ or other receptacles for later use.

### RELATED APPLICATIONS

This Patent Application is a continuation-in-part of the co-pending U.S. patent application Ser. No. 14/133,319, filed Dec. 18, 2013 and entitled “WATER SANITIZATION SYSTEM,” which is hereby incorporated by reference in its entirety.

### FIELD OF THE INVENTION

This invention generally relates to systems and methods for disinfecting and sanitizing a body of water. More particularly, this invention relates to non-chemical water sanitation systems.

### BACKGROUND OF THE INVENTION

Keeping swimming pools and spas clean and free of other germs and bacteria has historically meant adding harsh chemicals such as chlorine and bromine to the water. Using and storing such chemicals can be hazardous to humans and the environment. Consequently, there has been a push to find non-chemical alternatives.

In recent years, new technology has been introduced that attempts to eliminate the harmful chemicals. This technology consists of immersing ultraviolet radiating lamps and ionizers into the water stream of the pools and spas. The ultraviolet light and the ionizers kill germs and bacteria within the water of the pools and spas.

However, because these systems are often retrofitted into existing swimming pools and spas the cost of implementation is often high and thus is discouraging over other lower cost methods. The high cost of implementation is often associated with supplying power in sufficient quantity to the ultraviolet light fixtures and/or the ionizers. Some systems use batteries which must be changed often and may corrode causing a hazardous condition. Alternatively, some systems obtain power from the main AC supply of the pool or spa. In such cases, wire and conduits must be run which involves a substantial modification to the pool or spa including work by an electrician following local building, electrical, and fire codes and the procurement of permits. Additionally, some systems use photo-electric cells affixed to the ground or attached to the top of a floating head. In either case, the photo-electric cells are very expensive on a per watt basis and require a significant amount of space to generate a reasonable amount of power.

### SUMMARY OF THE INVENTION

A non-chemical sanitation system for a body of fluid comprises a floating base, an internal hydro-electric power generator, and one or more sanitizing mechanisms electrically powered by the hydro-electric power generator. In some embodiments, the one or more non-chemical sanitizing mechanisms comprise one or more ultraviolet LED lights. In some embodiments, the one or more non-chemical sanitization mechanisms comprise one or more ionizers. In some embodiments, the system is connected to a filter pipe and filter of a pool and the hydro-electric power generator is placed within the path of fluid flowing to or from the pool filter in order to generate power and power the one or more sanitization mechanisms.

In one aspect, a sanitizing head for sanitizing a body of fluid comprises a floating base, a hydro-electric power generator for electrically powering the sanitizing head, and one or more sanitization mechanisms for sanitizing the body of water. In some embodiments, the one or more sanitization mechanisms comprise one or more ultraviolet LED lights. Alternatively or in conjunction, the one or more sanitization mechanisms comprise one or more ionizers. In some embodiments, the floating base comprises a pool or spa sweep. In some embodiments, the sanitizing head comprises an intake pipe that is configured to couple to an filter pipe of a filter pump of the pool or spa. In further embodiments, the sanitizing head comprises a hydro impeller coupled to a power generator, wherein the hydro impeller is spun by water traveling the through the intake pipe in order to generate power. In some embodiments, the floating base comprises a solar panel. In some embodiments, the body of fluid comprises a pool or a spa.

In another aspect, a pool cleaner comprises a sweep head coupled to an intake pipe and an internally powered sanitization head comprising one or more sanitizing mechanisms. In some embodiments, the one or more sanitization mechanisms comprise one or more ultraviolet LED lights. Alternatively or in conjunction, the one or more sanitization mechanisms comprise one or more ionizers. In some embodiments, the sanitization head is powered by a hydro-electric power generator. In some embodiments, the pool cleaner is configured to couple to an filter pipe of a filter pump of the pool. In further embodiments, the sanitization head comprises a floating base. In some embodiments, the sanitization head comprises a solar panel.

In a further aspect, a pool sanitization system comprises a sweep head, a sweep pipe, a pool filter, and a sanitization head coupled to a filter pipe of the pool filter, wherein the sanitization head comprises a hydro-electric motor that is in the path of water traveling to the pool filter and wherein the hydro-electric motor powers the sanitization head.

In still a further aspect, a sanitizing head for sanitizing a body of water comprises a floating base, a hydro-electric power generator for electrically powering the sanitizing head, a water pipe coupled to the floating base, and one or more sanitization mechanisms coupled to an interior of the pipe for sanitizing the body of water. In some embdodiments, the hydro-electric power generator is located within the pipe. In some embodiments, the one or more sanitization mechanisms comprise one or more ultraviolet LED lights. Alternatively or in conjunction, the one or more sanitization mechanisms comprise one or more ionizers.

In another aspect, a non-chemical sanitation system for a body of water comprises a floating base, an internal hydro-electric power generator, and one or more sanitizing mechanisms electrically powered by the hydro-electric power generator.

In a further aspect, a water sanitization system uses pressurized water from a high pressure side of a pool pump. The pressure from the pool pump is able to spin the hydro-electric generator which powers one or more ultraviolet LED lights.

In still a further aspect, a water sanitizing system comprises an inlet port, a base coupled to the inlet port, one or more sanitization mechanisms coupled to the base, a mechanical mechanism for passing water through the base and over the one or more sanitization mechanisms in order to sanitize the water, and an outlet port for dispensing the sanitized water. In some embodiments, the one or more sanitizing mechanisms comprise one or more ultraviolet LED lights. Alternatively, or in conjunction, the one or more sanitization mechanisms comprise one or more ionizers. In some embodiments, the one or more sanitization mechanisms are powered by a solar cell. In some embodiments, the mechanical mechanism comprises a crank which operates a pump for passing the water through the base and over the one or more sanitization mechanisms in order to sanitize the water. In further embodiments, the crank also provides power to the one or more sanitization mechanisms. In some embodiments, the crank comprises a hand powered crank Alternatively, the crank comprises a wheel powered crank In some embodiments, the sanitized water is potable.

In an additional aspect, a non-chemical water sanitizing mechanism comprises an inlet tube, a base coupled to the inlet tube and comprising one or more sanitization mechanisms, a mechanically operated pump for passing water through the base and over the one or more sanitization mechanisms in order to sanitize the water, and an outlet tube for dispensing the sanitized water. In some embodiments, the one or more sanitization mechanisms comprise one or more ultraviolet LED lights. Alternatively, or in conjunction, the one or more sanitization mechanisms comprise one or more ionizers. In some embodiments, the pump comprises a crank operated pump. In further embodiments, the crank also provides power to the one or more sanitization mechanisms. In some embodiments, the crank comprises a hand powered crank In some embodiments, the crank comprises a wheel powered crank In some embodiments, the sanitized water is potable. In further embodiments, the mechanism is portable.

In a further aspect, a method of sanitizing water comprises placing an inlet tube into a body of water, activating a pump in order to pump the water through a sanitization body comprising one or more mechanisms for sanitizing the water and pumping the sanitized water through an outlet tube and into a water holding apparatus. In some embodiments, the pump comprises a crank operated pump. In further embodiments, the crank also provides power to the one or more sanitization mechanisms. In some embodiments, the crank comprises a hand powered crank. Alternatively, the crank comprises a wheel powered crank. In some embodiments, the sanitized water is potable.

### BRIEF DESCRIPTION OF THE DRAWINGS

FIG. 1 illustrates a high level view of a sanitation system for a body of water in accordance with some embodiments.

FIG. 2 illustrates a sanitizing head for a sanitation system, in accordance with some embodiments.

FIG. 3 illustrates an exploded view of a sanitizing head for a sanitation system, in accordance with some embodiments.

FIG. 4 illustrates a pool sweep and a sanitizing head, in accordance with some embodiments.

FIG. 5A illustrates an intake pipe for a sanitizing head, in accordance with some embodiments.

FIG. 5B illustrates a x-ray view of an intake pipe for a sanitizing head, in accordance with some embodiments.

FIG. 6A illustrates a sanitizing system in accordance with some embodiments.

FIG. 6B illustrates a close-up view of a sanitizing system in accordance with some embodiments.

FIG. 7 illustrates a sanitizing system in accordance with some embodiments.

FIG. 8 illustrates a schematic view of a sanitizing system in accordance with some embodiments.

FIG. 9 illustrates a method of sanitizing water in accordance with some embodiments.

### DETAILED DESCRIPTION OF THE INVENTION

A non-chemical sanitation system for a body of water comprises a floating base, an internal power system and one or more non-chemical sanitizers for killing germs and other bacteria within the body of water. The system is able to use an internal power source for powering the one or more non-chemical sanitizing mechanisms. For example, in some embodiments, the sanitation system is powered by a hydro-electric power system. The hydro-electric power system is able to generate power using water that flows through an intake pipe of the sanitation system. In some embodiments, the one or more non-chemical sanitizing mechanisms comprise one or more ultraviolet LED lights. In some embodiments, the one or more non-chemical sanitizing mechanisms comprise one or more ionizers.

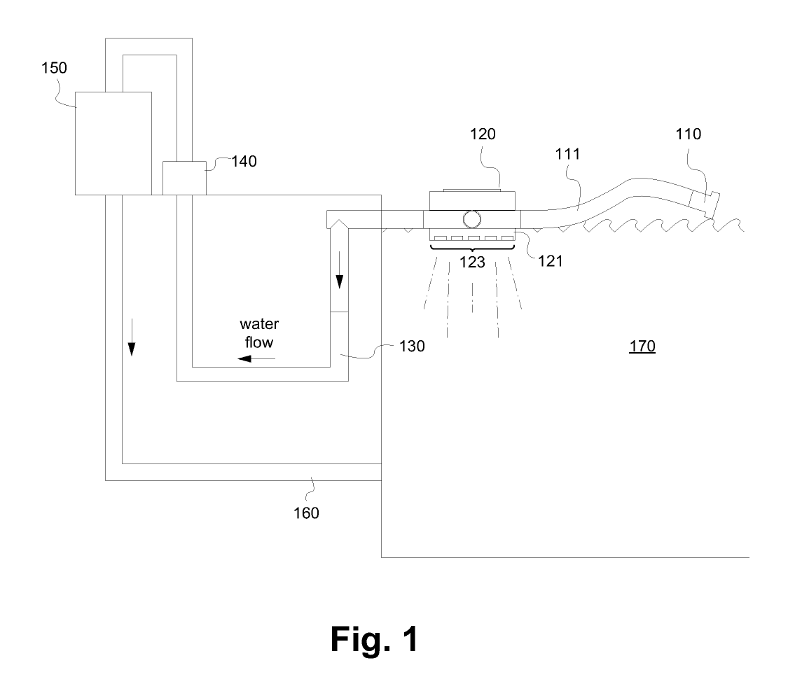

Referring now to FIG. 1, a high level view of a sanitation system for a body of water is depicted therein. The sanitation system 100 comprises a sanitizing head 120 coupled to a sweep pipe 110 and sweep head 110 at one end and coupled to a filter pipe 130 at the other end. In some embodiments, the sanitizing head 120 comprises one or more sanitization mechanisms 123 coupled to a base plate 121. The one or more sanitizing mechanisms 123 are able to disinfect and sanitize the pool 170 by eliminating germs and bacteria from the water. In some embodiments, the one or more sanitizing mechanisms 123 comprise one or more ultraviolet LED lights. In some embodiments, the one or more sanitizing mechanisms 123 comprise one or more ionizers.

The filter pipe 130 is coupled to the pool filter 150 and the pool pump motor 140. When the pool pump 140 is running, water is sucked from the pool 170, through the sweep head 110 and sweep pipe 110 and into the filter pipe 130 to the filter 150 where the water is filtered before it returns to the pool through the return pipe 160. In some embodiments, the sanitizing head 120 comprises a hydro-electric generator which is placed in the path of the water flowing to the pool filter. The hydro-electric generator is able to capture electrical power from the water flow through the pools filter 150 and the electrical power is able to be used to power the one or more sanitization mechanisms 123.

As shown in FIG. 1, the sanitizing head 120 floats on top of the water with the one or more sanitizing mechanisms 123 pointing in a downward direction. In this manner the sanitizing head 120 is able to disinfect and sanitize the pool water as it flows under the sanitizing head 120. In some embodiments, the one or more sanitizing mechanisms 123 are placed near the hydro-electric generator in order to disinfect and sanitize the pool water as it passes through the sanitizing head 120. Additionally, although the system 100 is shown implemented in a pool, as will be apparent to someone of ordinary skill in the art, the system 100 is able to be implemented in any appropriately desired body of water such as a pool or a spa. Further, although the sanitizing head 120 is shown floating on the surface of the water, it is able to be paced in a static location such as on a side of the pool or next to the pool's filter pipe 130.

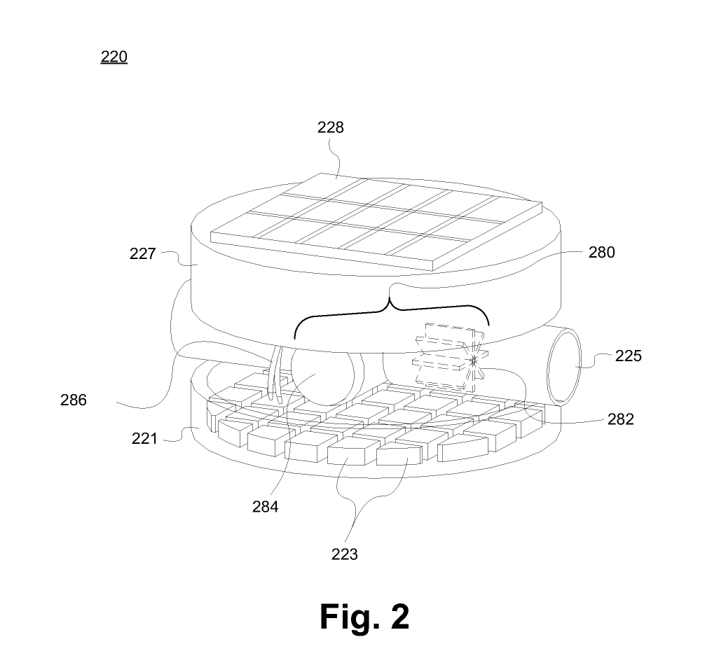

FIG. 2 illustrates a close-up view of the sanitization head 120 as discussed in relation to FIG. 1. The sanitization head 220 comprises a floating platform 227, a base plate 221 comprising one or more sanitization mechanisms 223 and an intake pipe 225. In some embodiments, the intake pipe 225 is coupled to a sweep pipe and a filter pipe, such as described above. Consequently, water traveling to the pool filter passes through the intake pipe 225 and contacts a hydro-electric power generator 280. As stated above, the hydro-electric generator 280 is able to capture electrical power from the water flow through the pools filter and the electrical power is able to be used to power the one or more sanitization mechanisms 223. As shown in FIG. 2, in some embodiments, the hydro-electric power generator 280 comprises an impeller 282 and a generator 284. As water flows through the intake pipe 225, the impeller 282 is spun generating power which is transferred from the generator 284 to the one or more sanitizing mechanisms 223 through a wired connection 286.

As described above, in some embodiments, the one or more sanitizing mechanisms 223 comprise one or more ultraviolet LED lights. In some embodiments, the one or more sanitizing mechanisms 223 comprise one or more ionizers. Additionally, although the one or more sanitizing mechanisms 223 are shown coupled to a base plate 221 of the sanitizing head 220, the one or more sanitizing mechanisms 223 are able to be placed at any appropriate location on the sanitizing head 220. For example, in some embodiments, the one or more sanitizing mechanisms are located on an interior of the intake pipe 225. In some embodiments, the sanitization head 220 comprises a solar panel 228 for providing additional power to the one or more sanitizing mechanisms 223.

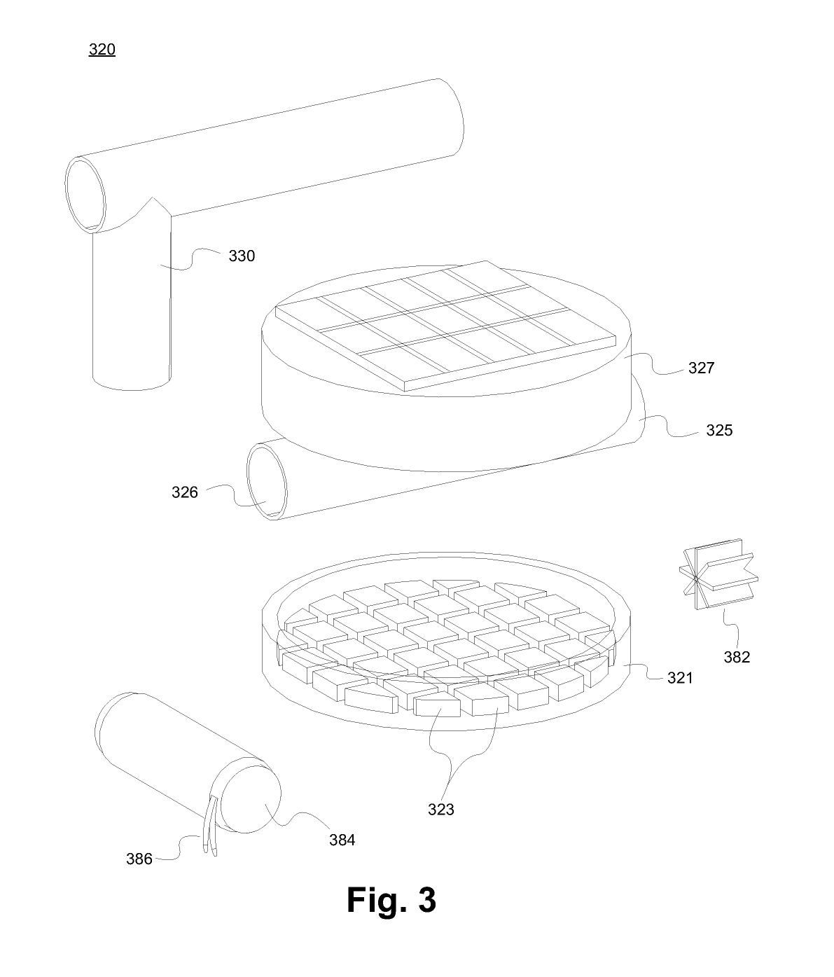

FIG. 3 illustrates an exploded view of a sanitization head 320 in accordance with some embodiments. The sanitization head 320 comprises a floating platform 327, a base plate 321 comprising one or more sanitization mechanisms 323 and an intake pipe 325. In some embodiments, the intake pipe 325 is coupled to a sweep pipe and a filter pipe 330, such as described above. As shown in FIG. 3, the hydro-electric generator comprises an impeller 382 and a generator 384. As water flows through the intake pipe 325, the impeller 382 is spun generating power which is transferred from the generator 384 to the one or more sanitizing mechanisms 323 through a wired connection 386.

As further shown in FIG. 3, the one or more sanitizing mechanisms 323 are shown coupled to a base plate 321. However, as described above, the one or more sanitizing mechanisms 323 are able to be placed at any appropriate location on the sanitizing head 320. For example, in some embodiments, the one or more sanitizing mechanisms are located on an interior of the intake pipe 325. In some embodiments, the sanitization head 320 comprises a solar panel 328 for providing additional power to the one or more sanitizing mechanisms 323.

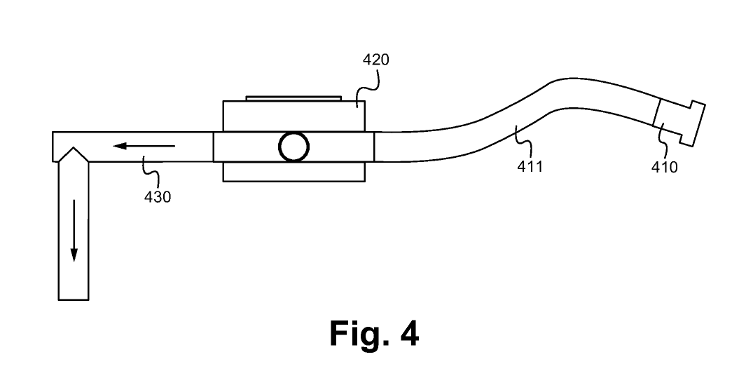

FIG. 4 illustrates a sanitization head attached to a pool sweep. The sanitization head 420 is similar to the sanitization heads 120, 220, and 320, as described above. As shown by the arrows of FIG. 4, water is sucked through the sweep head 410 and the sweep pipe 411 and through the sanitization mechanism 420 where it contacts a hydro-electric generator before passing to the filter pipe 430 and the pool filter (not shown).

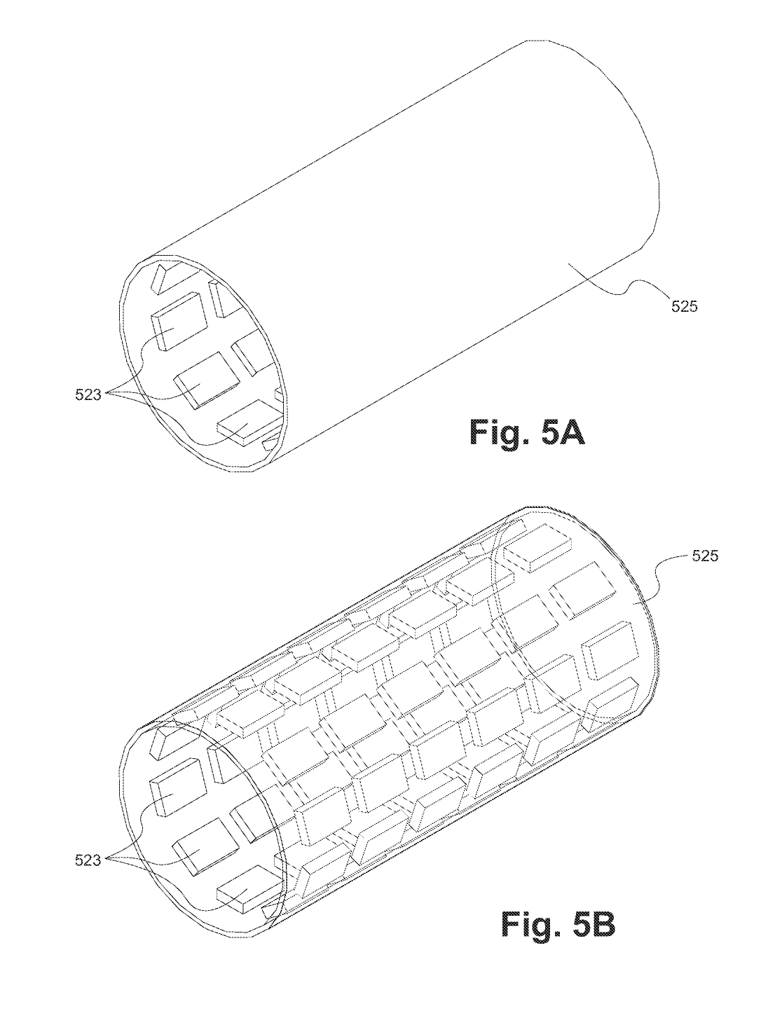

FIGS. 5A and 5B illustrate one or more sanitizing mechanisms 523 coupled to an interior of an intake pipe 525, such as shown in FIGS. 2 and 3. As shown within FIGS. 5A and 5B, the one or more sanitizing mechanisms 523 are coupled around an entirety of an interior of the intake pipe 525. As will be apparent to someone of ordinary skill in the art, any number of sanitizing mechanisms 523 are able to be coupled to the intake pipe 525 and in any appropriately desired configuration. When the one or more sanitizing mechanisms are located within the intake pipe 525 or a return pipe, the intensity of the one or more sanitizing mechanisms 523 are able to be increased without exposing the surrounding environment and pool area to the sanitizing process of the one or more sanitizing mechanisms 523.

In use, the sanitizing head and system is able to capture electrical power from water flow to a pool's filter using a small hydro-electric generator mounted within a floating head comprising one or more sanitizing mechanisms. Pool filter motors are typically very powerful and may range from one-half horse power to many horsepower depending upon the size of the system. Consequently, installing a hydro-electric generator within the path of the flowing water enables the system to recapture a high percentage of the power of the filter pump motor to be utilized for disinfecting and sanitizing the pool's water. For example, installing the hydro-electric generator in the path of the water from the high pressure side of a pool pump enables the system to spin the generator and power the infrared LED lights. Extracting high, electrical power, from water pressure, at the point of the pool, eliminates the need for more expensive distribution means and will result in more pools being disinfected using ultraviolet and electric sanitizing means.

Particularly, providing an internal power source to the sanitizing head and system eliminates the need for wires, conduits, electricians, and permits and enables the system to be implemented similarly within existing and new pool systems. Specifically, the sanitizing head is easily coupled to a pool's filter pipe and pump in order to power one or more sanitizing mechanisms to clean and disinfect the pool water using a process, which the pool system was already implementing. Consequently, the pool is able to be cleaned at a greater rate and at less cost than existing systems. Accordingly, the sanitizing head and system as described herein has many advantages.

In another aspect, a water sanitization system is able to sanitize water for drinking and other uses. A mechanically operable water sanitization system comprises an inlet port, an outlet port and a base comprising one or more sanitization mechanisms. A mechanical device such as a crank operated pump passes water through the base and by the one or more sanitization mechanisms. The one or more sanitization mechanisms sanitize the water and the water is passed out of the system through the outlet port. The outlet port is able to distribute the water, to a bucket and/or other receptacles for later use.

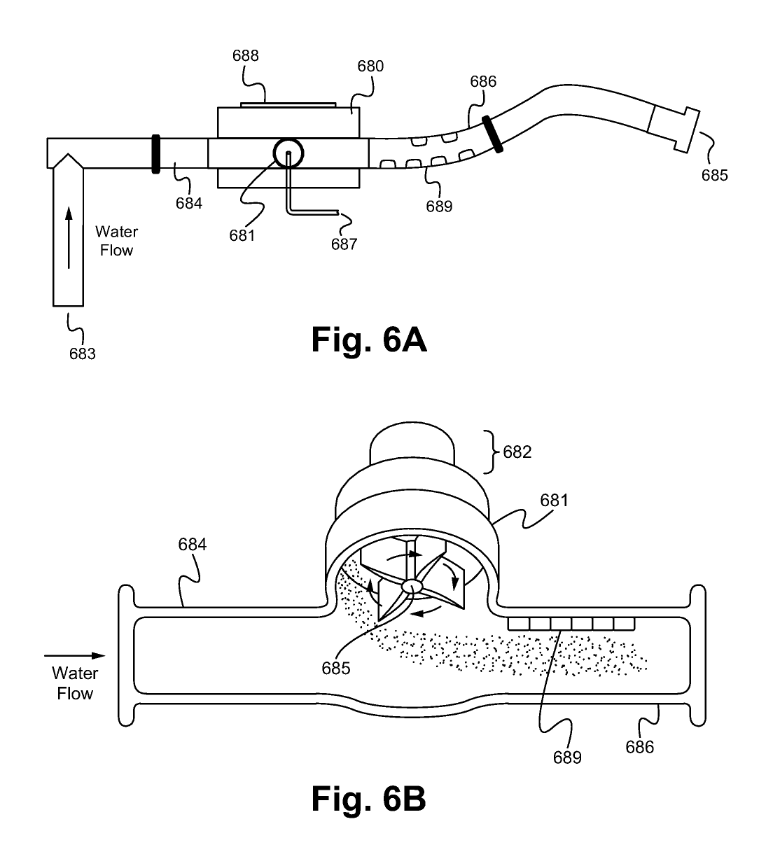

Referring now to FIG. 6A, a water sanitization system is depicted therein. The water sanitization system comprises an inlet port 684, a base 680 coupled to the inlet port 684, one or more sanitizing mechanisms 689 coupled to the base, a mechanical mechanism 681 for passing water through the base 680 and over the one or more santizing mechanisms 689 in order to sanitize the water, and an outlet port 686 for dispensing the sanitized water. As shown in FIG. 6A, the one or more sanitizing mechanisms 689 are located within the outlet port 686, however, the one or more sanitizing mechanisms 689 are able to be located at any appropriately desired location within the system. As further shown in FIG. 6A, in some embodiments, the mechanical mechanism 681 for passing water through the base 680 comprises a crank 682. In some embodiments, the crank 682 is turned by a hand operated crank 687.

The inlet port 684 is able to couple an inlet tube 683 which is able to be placed within the unsanitized water. The outlet port 686 is able to couple to an outlet tube 685 for dispensing the sanitized water to a bucket and/or other receptacle for later use. In some embodiments, the sanitized water comprises potable water.

In some embodiments, the one or more sanitizing mechanisms 689 comprise one or more ultraviolet LED lights. Alternatively, or in conjunction, in some embodiments, the one or more sanitizing mechanisms 689 comprise one or more ionizers. In some embodiments, the one or more sanitizing mechanisms 689 are powered by a solar cell. Alternatively, in some embodiments, the one or more sanitizing mechanisms 689 are powered by the crank 682.

FIG. 6B illustrates a close-up view of the he mechanical mechanism 681 for passing water through the base 680. As shown in FIG. 6B, in some embodiments, the crank 682 turns an impeller 685 which circulates water from the inlet port 684 and over the one or more sanitizing mechanisms 689 to the outlet port 686. As described above, in some embodiments, the one or more sanitizing mechanisms 689 are located within the outlet port 686. However, the one or more sanitizing mechanisms 689 are able to be located at any appropriately desired location within the system.

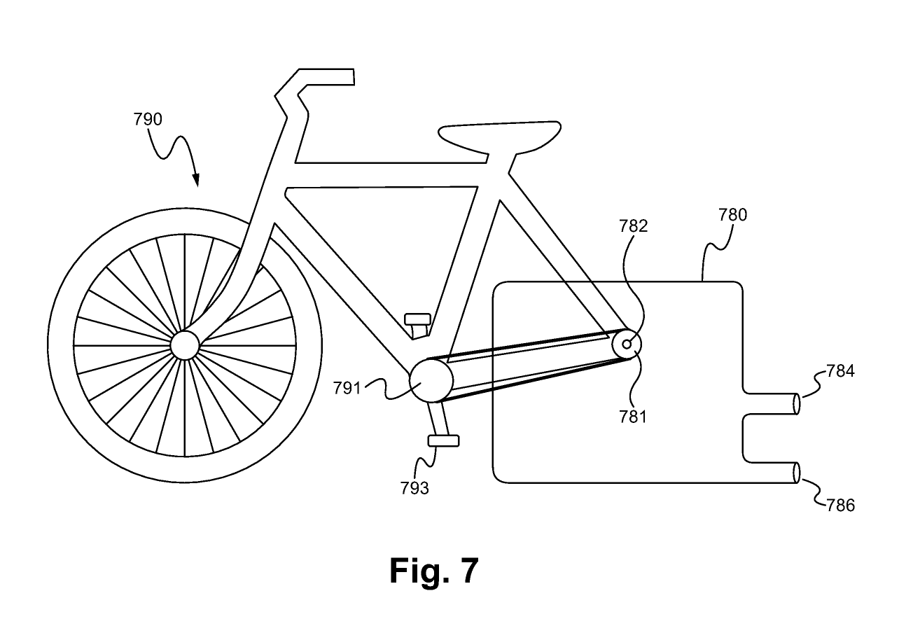

In some embodiments, the crank comprises a wheel-powered crank For example, as shown within FIG. 7, the mechanical mechanism 781 for pumping the water through the body 780 is coupled to a bicycle 790. The pedals 793 of the bicycle 790 are turned in order to operate the crank 682 and move the impeller, such as described above. As shown within FIG. 7, the inlet port 784 and the outlet port 686 are located on the same side of the body 780. However, the inlet port 784 and the outlet port 686 are able to be located at any appropriately desired location. Although FIG. 7 shows the water sanitization system coupled to a bicycle 790, the water sanitization system is able to couple to any appropriately desired wheeled device for turning the crank 682. For example, in some embodiments, the system is coupled to a wheeled cart and/or other device for turning the crank 782.

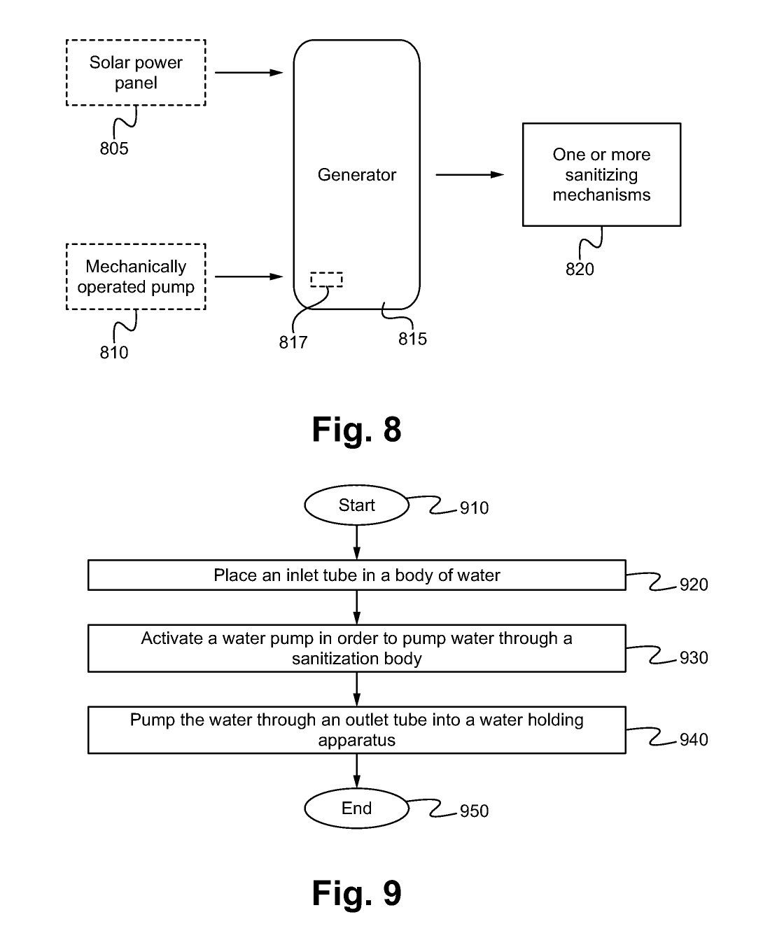

FIG. 8 illustrates a schematic view of a water sanitization system, such as described above. The water sanitization system 800 comprises a generator 815 for providing power to one or more sanitizing mechanisms 820. As described above, in some embodiments, the one or more sanitizing mechanisms 820 comprise one or more ultraviolet LED lights. Alternatively, or in conjunction, in some embodiments, the one or more sanitizing mechanisms 820 comprise one or more ionizers. In some embodiments, the one or more sanitizing mechanisms 820 are powered by a solar power cell 805, which provides power to the generator 815. Alternatively or in conjunction, in some embodiments, the one or more sanitizing mechanisms 820 are powered by a mechanically operated pump 810 which provides power to the generator. As shown within FIG. 8, in some embodiments the generator 815 comprises a storage cell 817 for storing the generated power.

FIG. 9 illustrates a method of sanitizing water. The method begins in the step 910. In the step 920, an inlet tube is placed within a body of water. Then, in the step 930, a water pump is activated in order to pump the water through a sanitization body. As described above, in some embodiments, the pump comprises a crank operated pump. For example, in some embodiments, the pump is operated by a hand crank Alternatively, in some embodiments, the crank comprises a wheel powered crank As described above, in some embodiments, the sanitizing body comprises one or more ultraviolet LED lights for sanitizing the water. Alternatively, or in conjunction, in some embodiments, the sanitizing head comprises one or more ionizers for sanitizing the water. In some embodiments, the sanitized water comprises potable water.

In the step 940, after the water has been sanitized, it is pumped through an outlet of the sanitizing head and into a water holding apparatus. The method ends in the step 950. In operation, the sanitization system is able to sanitize water for drinking and other uses. A mechanically operable water sanitization system comprises an inlet port, an outlet port and a base comprising one or more sanitization mechanisms. A mechanical device such as a crank operated pump passes water through the base and by the one or more sanitization mechanisms. The one or more sanitization mechanisms sanitize the water and the water is passed out of the system through the outlet port. The outlet port is able to distribute the water to a bucket and/or other receptacle for later use.

In operation, the sanitization system is able to be implemented within a portable device. Additionally, because the device is mechanically operated, it is able to be used without an external power source. Specifically, the sanitization system is able to be manually operated or coupled with a wheeled device in order to pump water from a source through a sanitization head in order to sanitize the water for use as drinking water or in other applications where clean water is desired. Accordingly, the mechanically operated sanitization system as described herein has many advantages.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A water sanitizing system comprising:
a. an inlet port;
b. a base coupled to the inlet port;
c. one or more sanitization mechanisms coupled to the base;
d. a mechanical mechanism for passing water through the base and over the one or more sanitization mechanisms in order to sanitize the water; and
e. an outlet port for dispensing the sanitized water.

2. The water sanitizing system of claim 1, wherein the one or more sanitization mechanisms comprise one or more ultraviolet LED lights.

3. The water sanitizing system of claim 1, wherein the one or more sanitization mechanisms comprise one or more ionizers.

4. The water sanitizing system of claim 1, wherein the one or more sanitization mechanisms are powered by a solar cell.

5. The water sanitizing system of claim 1, wherein the mechanical mechanism comprises a crank which operates a pump for passing the water through the base and over the one or more sanitization mechanisms in order to sanitize the water.

6. The water sanitizing system of claim 5, wherein the crank also provides power to the one or more sanitization mechanisms.

7. The water sanitizing system of claim 5, wherein the crank comprises a hand powered crank

8. The water sanitizing system of claim 5, wherein the crank comprises a wheel powered crank

9. The water sanitizing mechanism of claim 1, wherein the sanitized water is potable.

10. A non-chemical water sanitizing mechanism comprising:
a. an inlet tube;
b. a base coupled to the inlet tube and comprising one or more sanitization mechanisms;
c. a mechanically operated pump for passing water through the base and over the one or more sanitization mechanisms in order to sanitize the water; and
d. an outlet tube for dispensing the sanitized water.

11. The water sanitizing mechanism of claim 10, wherein the one or more sanitization mechanisms comprise one or more ultraviolet LED lights.

12. The water sanitizing mechanism of claim 10, wherein the one or more sanitization mechanisms comprise one or more ionizers.

13. The water sanitizing mechanism of claim 10, wherein the pump comprises a crank operated pump.

14. The water sanitizing mechanism of claim 13, wherein the crank also provides power to the one or more sanitization mechanisms.

15. The water sanitizing mechanism of claim 13, wherein the crank comprises a hand powered crank.

16. The water sanitizing mechanism of claim 13, wherein the crank comprises a wheel powered crank.

17. The water sanitizing mechanism of claim 10, wherein the sanitized water is potable.

18. The water sanitizing mechanism of claim 10, wherein the mechanism is portable.

19. A method of sanitizing water comprising:
a. placing an inlet tube into a body of water;
b. activating a pump in order to pump the water through a sanitization body comprising one or more mechanisms for sanitizing the water; and
c. pumping the sanitized water through an outlet tube and into a water holding apparatus.

20. The method of claim 19, wherein the pump comprises a crank operated pump.

21. The method of claim 20, wherein the crank also provides power to the one or more sanitization mechanisms.

22. The method of claim 20, wherein the crank comprises a hand powered crank.

23. The method of claim 20, wherein the crank comprises a wheel powered crank

24. The method of claim 19, wherein the sanitized water is potable.
